(19) United States
(12) Patent Application Publication
(10) Pub. No.: US 2021/0078849 A1
(43) Pub. Date: Mar. 18, 2021

(54) System for providing a smart bottled water delivery service based on usage analysis

(71) Applicant: Kuang F CHENG, Taipei (TW)

(72) Inventor: Kuang F CHENG, Taipei (TW)

(21) Appl. No.: 17/103,188

(22) Filed: Nov. 24, 2020

Related U.S. Application Data
(63) Continuation-in-part of application No. 16/856,063, filed on Apr. 23, 2020.
Application No. 16/856,063 is a continuation of application No. 15/978,201, filed on May 14, 2018, now abandoned.

(51) Int. Cl. B67D 3/00; G01F 23/20

(52) U.S. Cl. CPC B67D 3/0032; B67D 1/0009; G01F 23/20

(57) ABSTRACT

A system can coordinate a smart bottled water delivery service, which comprises one or more processors of a network-accessible server and one or more memory resources storing program instructions. The system determines whether a trigger event has occurred based on a first data and a second data, which are related to a total number of bottled water currently hold by a customer, and a total number of the bottled water used up by the customer, respectively. After the trigger event has occurred, the system sends a replenishment message to a customer's device. When the system receives data associated with the replenishment order, it determines a pool of candidate delivery drivers that can satisfy a criterion. Then the system provides an instruction to a device of a selected delivery driver to dispatch the selected delivery driver with a particular vehicle to a designated collection, storing and distribution device.

### FIELD OF THE INVENTION

The present disclosure relates generally to a bottled water delivery service and more specifically, but not exclusively, to systems for providing a smart bottled water delivery service based on usage analysis.

### BACKGROUND OF THE INVENTION

Drinking water refers to the water that meets the required quality standards and safe for drinking, food preparation, personal hygiene and so on. Currently, water plants provide services for directly supplying drinking water to homes, offices, or other places (usually in packaged bottles). However, generally, water plants are far away from where the customer located, and thus a long distance of transportation is needed. Furthermore, sometimes the water plants prefer to send a water tank only when a specific amount of orders is reached. Therefore, the overall operations are not economic and efficient.

In areas having higher population density, water stations are installed in various locations. Water plants supply water to water stations, the customer can go to the water stations to buy water, but the customer needs take longer time to take water by himself or herself Generally, bottled water is heavy and also a burden for the customer and thus the quantity of water to be transported is limited. Therefore, this way is only suitable to the customer who needs a small quantity.

Furthermore, many users use water dispensers to store and dispense drinking water. Bottled water dispensers typically use 5 gallon or 10 gallon bottle on top of the unit. If water in the bottle ran out, the empty bottle is taken down from the water dispenser and another one is installed therein. It may give rise to a problem that the user cannot readily know how much water or how many bottled water have been used. Thus the timing for place a next order for purchasing water would be hard to predict.

### SUMMARY OF THE INVENTION

According to an aspect, there is disclosed a system for providing a smart bottled water delivery service based on usage analysis, comprising: one or more processors of a network-accessible server; and one or more memory resources storing program instructions when executed on the one or more processors, cause the system to: retrieving a plurality of order records stored in an archive to obtain a first data of a total number of bottled water currently hold by a customer, wherein each of the bottled water is a pre-assigned machine-readable code for the purposes of identification, which is attached on a container of the bottled water; retrieving a second data of a total number of the bottled water used up by the customer, that is generated by scanning the machine-readable code on the empty container of the bottled water which hold by the customer; determining whether a trigger event has occurred based on the first data and the second data; after the trigger event has occurred, sending a replenishment message to a customer's device for the customer to confirm whether or not to place a replenishment order; receiving data associated with the replenishment order, wherein the replenishment order indicating a customer information, a destination location, a quantity of bottled water and a type of water for the smart bottled water delivery service; determining a pool of candidate delivery drivers that can satisfy a criterion based on a current location of the candidate delivery drivers, a capacity of a vehicle of the candidate delivery drivers, locations of a plurality of available collection, storing and distribution devices and the destination location, wherein the collection, storing and distribution devices being situated at a particular location where the candidate delivery drivers can access and exchange bottled water; providing an instruction to a device of a selected delivery driver to dispatch the selected delivery driver with a particular vehicle to a designated collection, storing and distribution device and then a designated destination location after fetching bottled water according to the bottled water delivery request from the designated collection, storing and distribution device.

According to an aspect, there is disclosed a system for providing a smart bottled water delivery service based on usage analysis, comprising: one or more processors of a network-accessible server; and one or more memory resources storing program instructions when executed on the one or more processors, cause the system to: retrieving a plurality of order records stored in an archive to obtain a first data of a total number of bottled water currently hold by a customer, wherein each of the bottled water is a pre-assigned machine-readable code for the purposes of identification, which is attached on a container of the bottled water; retrieving a second data which is dependent on the following: a total number of the bottled water used up by the customer, that is generated by scanning the machine-readable code on the empty container of the bottled water which hold by the customer; and a detection of a remainder amount or a consumed amount of the bottled water in use; determining whether a trigger event has occurred based on the first data and the second data; after the trigger event has occurred, sending a replenishment message to a customer's device for the customer to confirm whether or not to place a replenishment order; receiving data associated with the replenishment order, wherein the replenishment order indicating a customer information, a destination location, a quantity of bottled water and a type of water for the smart bottled water delivery service; determining a pool of candidate delivery drivers that can satisfy a criterion based on a current location of the candidate delivery drivers, a capacity of a vehicle of the candidate delivery drivers, locations of a plurality of available collection, storing and distribution devices and the destination location, wherein the collection, storing and distribution devices being situated at a particular location where the candidate delivery drivers can access and exchange bottled water; providing an instruction to a device of a selected delivery driver to dispatch the selected delivery driver with a particular vehicle to a designated collection, storing and distribution device and then a designated destination location after fetching bottled water according to the bottled water delivery request from the designated collection, storing and distribution device.

### BRIEF DESCRIPTION OF THE DRAWINGS

FIG. 1A through FIG. 1D illustrate an example for the smart bottled water delivery service, according to one or more embodiments.

FIG. 2 is an example of the collection, storing and distribution devices, according to one or more embodiments.

FIG. 3A through FIG. 3D illustrate an example for the smart bottled water delivery service, according to one or more embodiments.

FIG. 4 is a block diagram of the system according to one or more embodiments.

FIG. 5 depicts a flow chart of the method for a smart bottled water delivery service, according to one or more embodiments.

FIG. 6 depicts a flow chart of the method for a smart bottled water delivery service, according to one or more embodiments.

FIG. 7 depicts a flow chart of the method for a smart bottled water delivery service, according to one or more embodiments.

FIG. 8 depicts a flow chart of the method for a smart bottled water delivery service, according to one or more embodiments.

FIG. 9 is a block diagram of a computer system upon which examples described herein may be implemented.

FIG. 10 is a mobile computing device upon which examples described herein may be implemented.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

In the following description, numerous details are set forth to provide an understanding of the present disclosure. However, it will be understood by those skilled in the art that the present disclosure may be practiced without these details and that numerous variations or modifications from the described embodiments may be possible.

The terms used in the description of various embodiments are only for the purpose of describing specific examples, and are not intended to be limiting. Unless the context clearly indicates otherwise, or does not deliberately limit the quantity of the assembly, the singular forms “a”, “an” and “the” used herein also include plural forms. On the other hand, the terms “comprising” and “including” are intended to be included, meaning that there may be additional assemblies other than the listed assemblies.

It should be understood that the description order of various embodiments should not be explained as implying that the operations or steps must be dependent on the order, and alternative embodiments may use the order different from the order described herein to perform the steps, operations, methods, etc.

The following terms as used herein have the meanings indicated.

The term “transport driver” refers to a transport provider hired or dispatched by a vendor of bottled water to transport a large amount of bottled waters from a water plant to an intermediate station for temporarily storing. In an example, the transport driver can be individual truck owners, or an entity that controls a fleet of vehicles.

The term “delivery driver” refers to a person who drives or intends to imminently drive or otherwise control operation of the vehicle.

The term “customer device”, “delivery driver device”, and/or “mobile device” refer to devices corresponding to desktop computers, cellular devices or smartphones, personal digital assistants (PDAs), laptop computers, tablet devices, etc., that can provide network connectivity and processing resources for communicating with the system over one or more networks. The customer device and the delivery driver device can each operate a designated service application (e.g., a customer application and a delivery driver application, respectively) that is configured to communicate with the system or the processor. The delivery driver device can also correspond to a computing device that is installed in or incorporated with a vehicle, such as part of the vehicle's on-board computing system.

One or more embodiments described herein may be implemented through the use of instructions that are executable by one or more processors. These instructions may be carried on one or more non-transitory computer-readable mediums. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as flash memory (such as carried on smartphones, multifunctional devices, or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

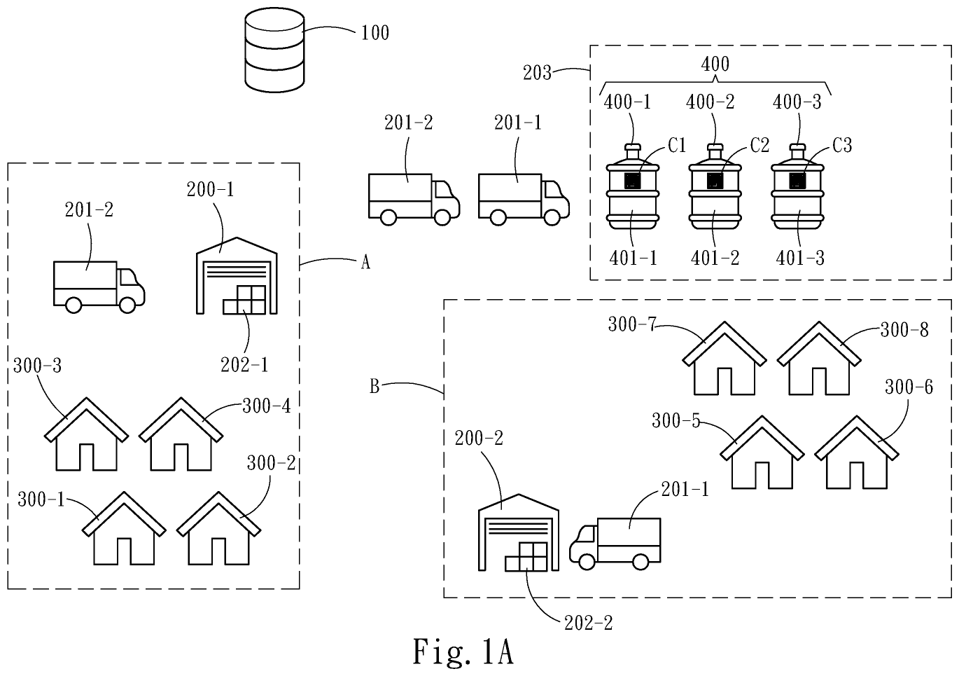

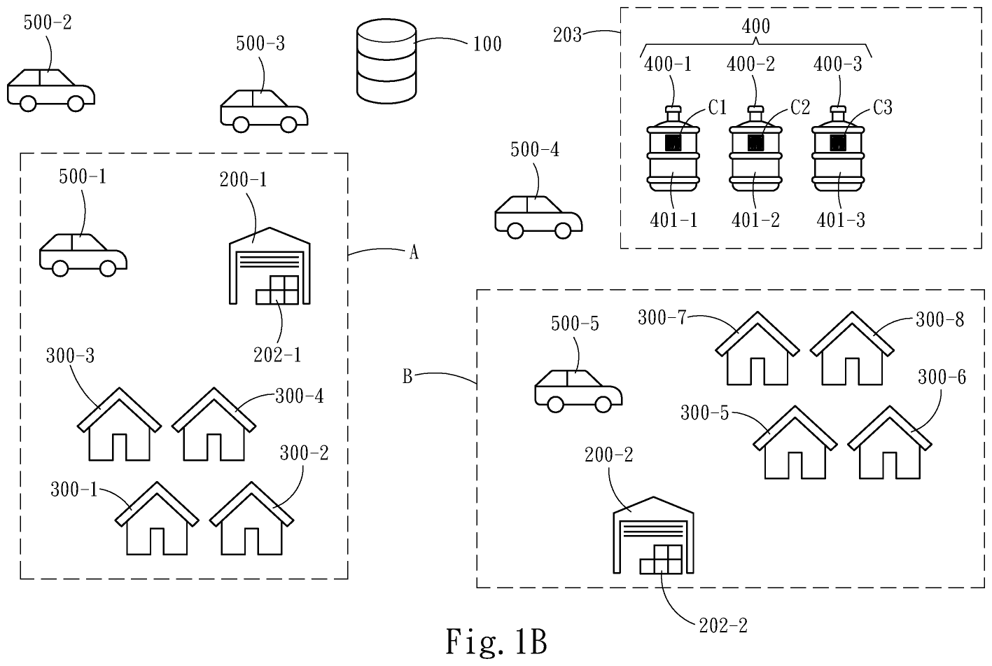

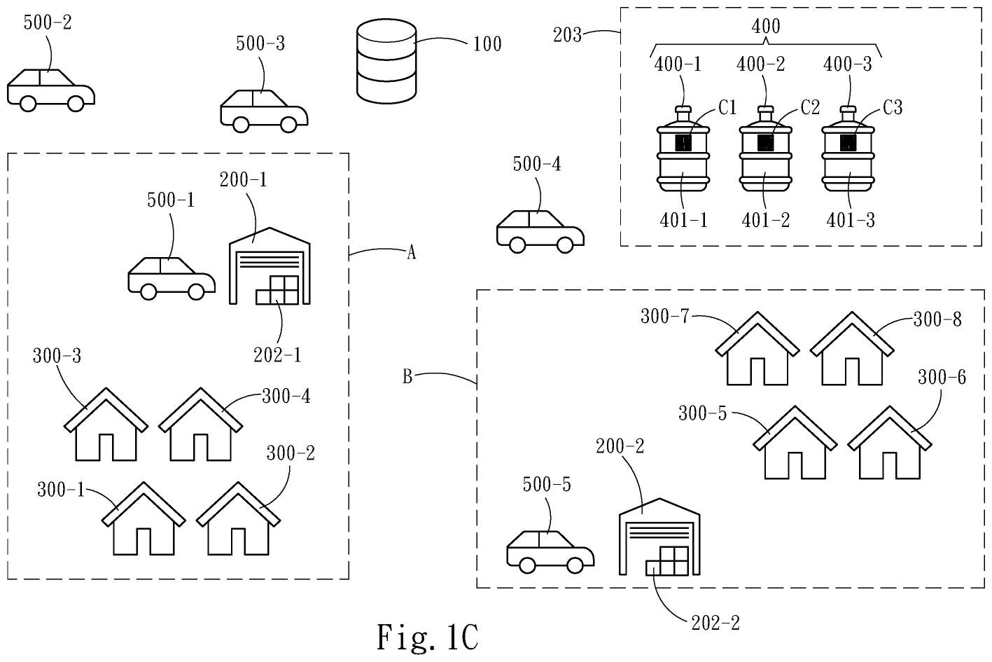

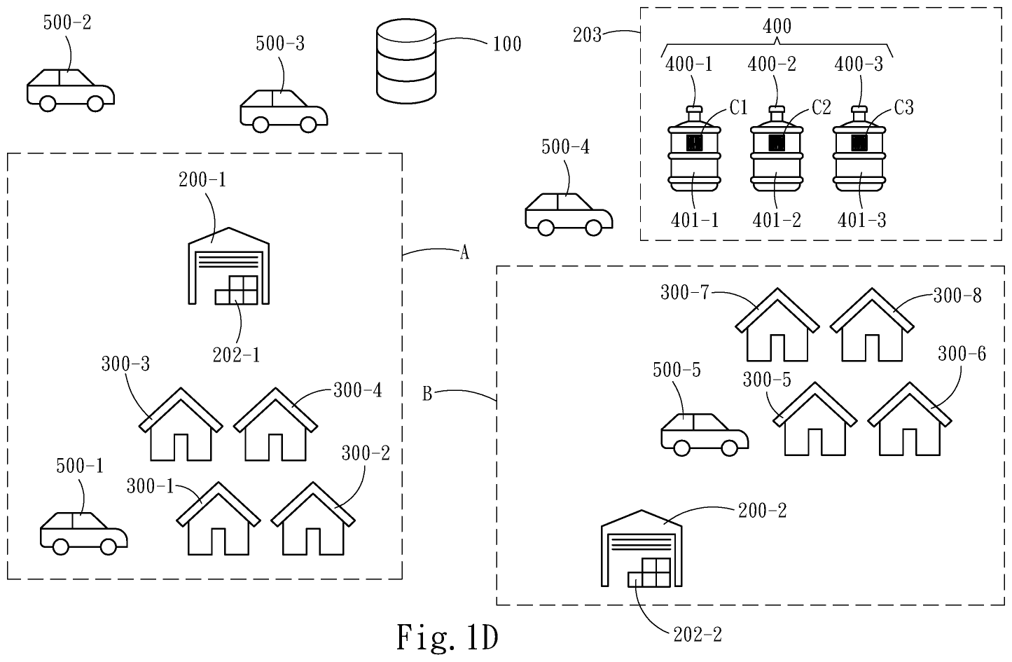

The present disclosure provides a system and method for a smart bottled water delivery service based on container-relevant information, which is obtained and collected through process of the service. FIG. 1A through FIG. 1D illustrate an example for the smart bottled water delivery service, according to one or more embodiments also show the relationship between the service provider, the customer, the transport driver and the delivery driver. The example such as shown with FIG. 1A through FIG. 1D may be implemented using, for example, a server or a combination of servers, communicating with mobile computing devices carried by the service providers and the users for the smart bottled water delivery service. In variations, some or all the functionality described with the system may be implemented using a distributed computing environment, such as provided by client computers and/or mobile computing devices which communicate with the network service.

The architecture of the system described in FIG. 1A through FIG. 1D includes a network-accessible server 100, a plurality of collection, storing and distribution devices 200-1, 200-2, a plurality of trucks 201-1, 201-2, a water source 203, a plurality of destination locations 300-1, 300-2, 300-3, 300-4, 300-5, 300-6, 300-7, 300-8, a plurality of bottled waters 400-1, 400-2, 400-3, a plurality of vehicles 500-1, 500-2, 500-3, 500-4, 500-5. In the present disclosure, each of the plurality of bottled waters 400-1, 400-2, 400-3 comprises a reusable container 401-1, 401-2, 401-3 and a unique individual machine-readable code C1, C2, C3 attached onto the container 401-1, 401-2, 401-3. The unique individual machine-readable code C1, C2, C3 is pre-assigned to the container 401-1, 401-2, 401-3 based on at least one batch information of the corresponding bottled water 400-1, 400-2, 400-3. In an example, the batch information includes identification number (ID), water source, water hardness, quality standards, manufacturer, treatment, bottling date, and etc. In another example, the unique individual machine-readable code is corresponding to an identification number of the container which is used for tracking the container.

As shown in FIG. 1A, the server 100 and the devices 200-1, 200-2 are operated by the service provider, while the destination locations 300-1, 300-2, 300-3, 300-4 are houses or offices where the customer located or the places where the customer intended to deliver the bottled water. The trucks 201-1, 201-2 may be operated or hired by the service provider. The trucks 201-1, 201-2, for example, could be a truck or a van that is able to load a plenty of bottled waters. The water source 203 is a place where can supply purified water and fill the purified water in the containers 401-1, 401-2, 401-3 to produce the bottled water. Each of the trucks 201-1, 201-2 is driven by the transport driver, which is dispatched by the service provider to go to the water source 203 to load a predetermined amount of bottled waters and distribute them to the devices 200-1, 200-2. As described herein, the transport driver refers to a driver operating the trucks 201-1, 201-2 and a transport driver refers to a driver operating the vehicles 201-1, 201-2. According to some examples, the drivers are person. While in other examples, an autonomous vehicle may be used so that the drivers may refer to electronic devices. The trucks 201-1, 201-2 are equipped with the truck driver devices, respectively.

Referring back to FIG. 1A, at the beginning of the smart bottled water delivery service process, the service provider schedules the trucks 201-1, 201-2 to arrive at the water source 203 to transport a plurality of bottled waters 400. The trucks 201-1, 201-2 deliver the bottled waters 400 to the devices 200-1, 200-2, respectively. Then the bottled waters 400 could be stored in the devices 200-1, 200-2.

As shown in FIG. 1B through FIG. 1D, the vehicles 500-1, 500-2, 500-3, 500-4, 500-5 may be a vehicle that operated by an individual, operated semi-autonomously or fully autonomously, operated remotely, or any combination thereof. The vehicles 500-1, 500-2, 500-3, 500-4, 500-5, for example, could be any type/size of car or motorcycle (e.g., sedan, sport utility vehicle, electric vehicle, limousine, etc.) to participate in the smart bottled water delivery service. The vehicles 500-1, 500-2, 500-3, 500-4, 500-5 are equipped with the delivery driver devices, respectively. The delivery driver of the vehicles 500-1, 500-2, 500-3, 500-4, 500-5 could obtain a plurality of bottled waters 400-1, 400-2, 400-3 from the devices 200-1, 200-2 and distribute the bottled waters 400-1, 400-2, 400-3 to the destination locations 300-1, 300-2, 300-3, 300-4. The detailed description will be presented later in the specification.

In an example, a plurality of service regions A, B are defined based on a given distance from where the devices 201-1, 201-2 are located. The destination locations 300-1, 300-2, 300-3, 300-4 are houses or offices where the customer located within the service region A and the destination locations 300-5, 300-6, 300-7, 300-8 are houses or offices where the customer located within the service region B. For instance, service region A may represent Berkeley City and service region B may represent Concord City in California.

When offering the smart bottled water delivery service, the customer initially makes a bottled water delivery request by using a service application on his or her customer device.

After the server 100 receives a data associated with the bottled water delivery request, it determines a pool of candidate delivery drivers satisfies a criterion based on a current location of the candidate delivery drivers, a capacity of a vehicle of the candidate delivery drivers, locations of a plurality of available collection, storing and distribution devices 200-1, 200-2 and the destination location 300-1, 300-2, 300-3, 300-4, 300-5, 300-6, 300-7, 300-8. As shown in FIG. 1B, the candidate delivery drivers may include the drivers of the vehicles 500-1, 500-2, 500-3, 500-4, 500-5.

As illustrated, for example, in FIG. 1B, when the customer makes the bottled water delivery request to deliver the bottled water 400 to the destination location 300-1, 300-5. the drivers of the vehicles 500-1, 500-5 may be selected. The server 100 sends an instruction to the drivers of the vehicles 500-1, 500-5 to dispatch the selected delivery driver with the particular vehicle 500-1, 500-5 to the designated collection, storing and distribution devices 200-1, 200-2, as shown in FIG. 1C. After picking up the bottled waters 400 from the devices 200-1, 200-2, the delivery driver with the vehicle 500-1, 500-5 respectively move to the designated destination location 300-1, 300-5, as shown in FIG. 1D.

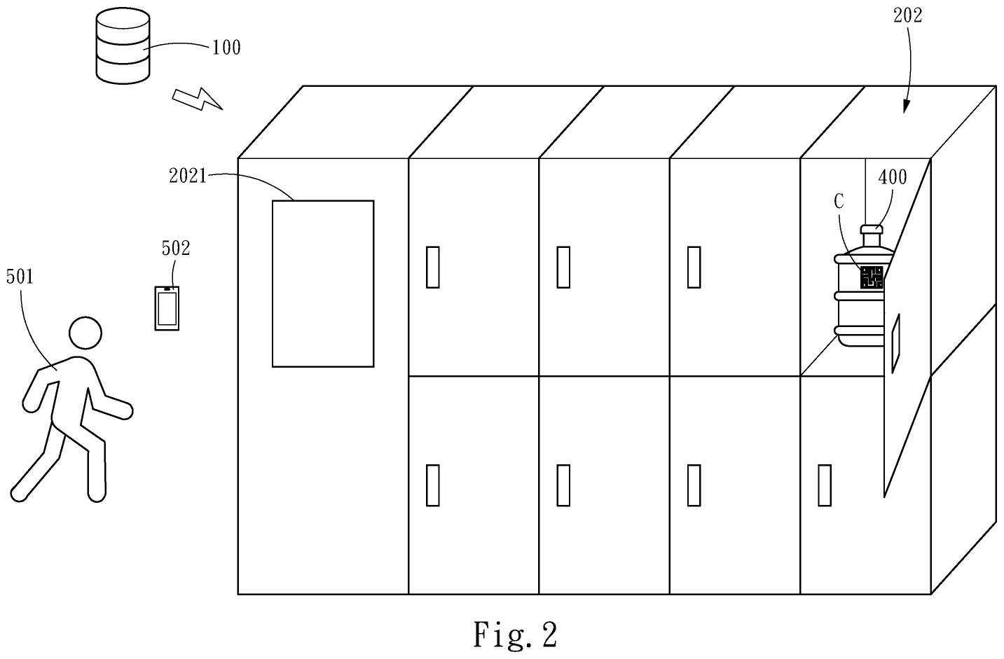

In an example, each of the devices 200-1, 200-2 includes a group of storage devices 202-1, 202-2 with a lock installed in a station, a warehouse, a storage area, or any other similar facility, to which the present invention is not limited. FIG. 2 is an example of the collection, storing and distribution devices, according to one or more embodiments. As shown in FIG. 2, the storage devices 202 are a plurality of keyless smart lockers with a control panel 2021 installed in a warehouse to store a plurality of bottled waters 400. The storage devices 202 are wirelessly connected to the server 100 and are be administered from the server 100. When a delivery driver 501 is picking up the bottled waters 400, the delivery driver 501 may unlocked (or activated/controlled) the storage device 202 by using digital password code, face recognition, or fingerprint through the control panel 2021. Alternatively, the delivery driver 501 may unlocked (or activated/controlled) the storage device 202 by using contactless technology (such as NFC or Bluetooth) through the communication between the storage device 202 and a delivery driver device 502.

When the delivery driver 501 arrives the designated collection, storing and distribution device. The server 100 authenticates whether the delivery driver 501 is the one that received the instruction. In an example, the authentication is a process of verifying whether the delivery driver 501 is the one received the instruction by scanning a code (QR code or bar code) shown with the delivery driver device 502 or using NFC. The storage device 202 may be installed with a scanner or a NFC reader to process the authentication. Once the authentication is successful, the storage device 202 will allow the delivery driver 501 to get the bottled water. In an example, the locker will open up when the authentication is successful.

In the present disclosure, each of the bottled waters 400-1, 400-2, 400-3 is pre-assigned the unique individual machine-readable code C1, C2, C3 by attaching onto a container 401-1, 401-2, 401-3 thereof. In an example, the unique individual machine-readable code is a QR code. By this way, each of the container or the bottled waters 400-1, 400-2, 400-3 became distinguishable and could be tracked and identified so the service provider can improve the management of the bottled water delivery service. More specifically, an usage analysis can be conducted based on identifying of each bottled water.

In an embodiment, the usage analysis for a particular customer is performed by obtaining and comparing a first data indicating a total number of the bottled water currently hold by the customer and a second data of a total number of the bottled water used up by the customer. The detailed description will be presented below.

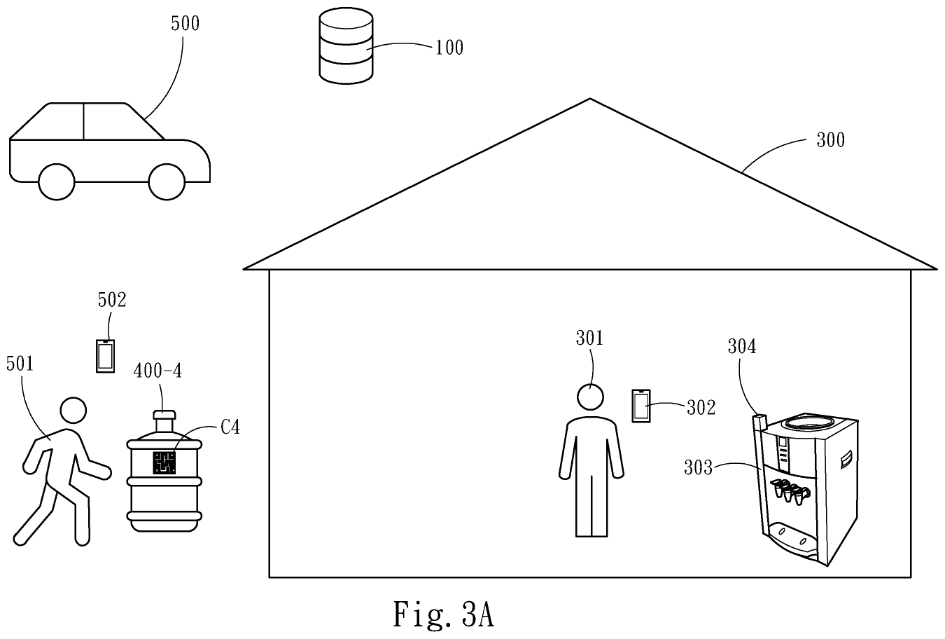

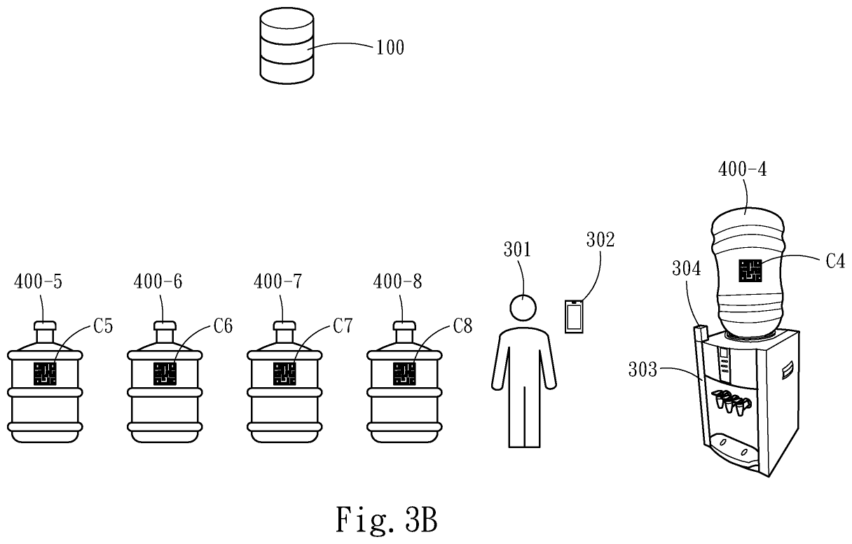

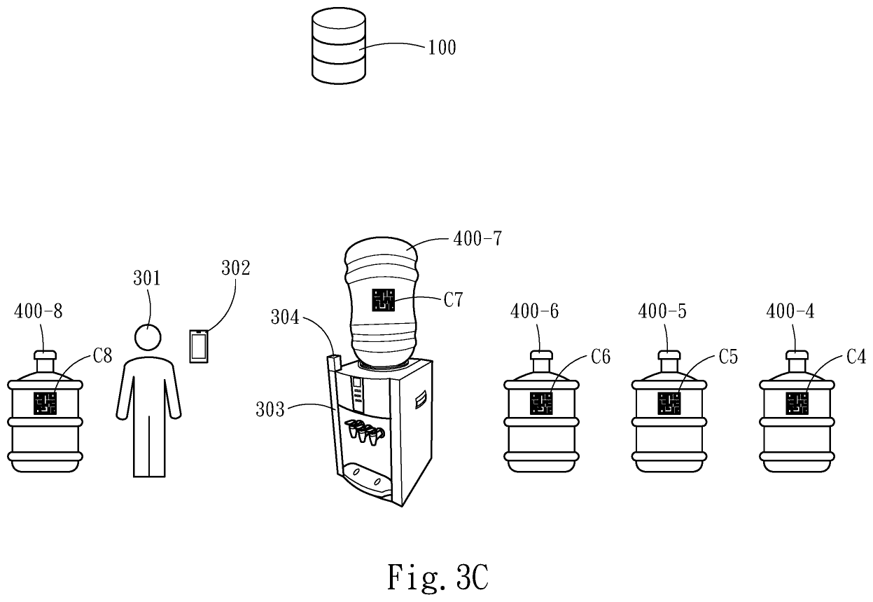

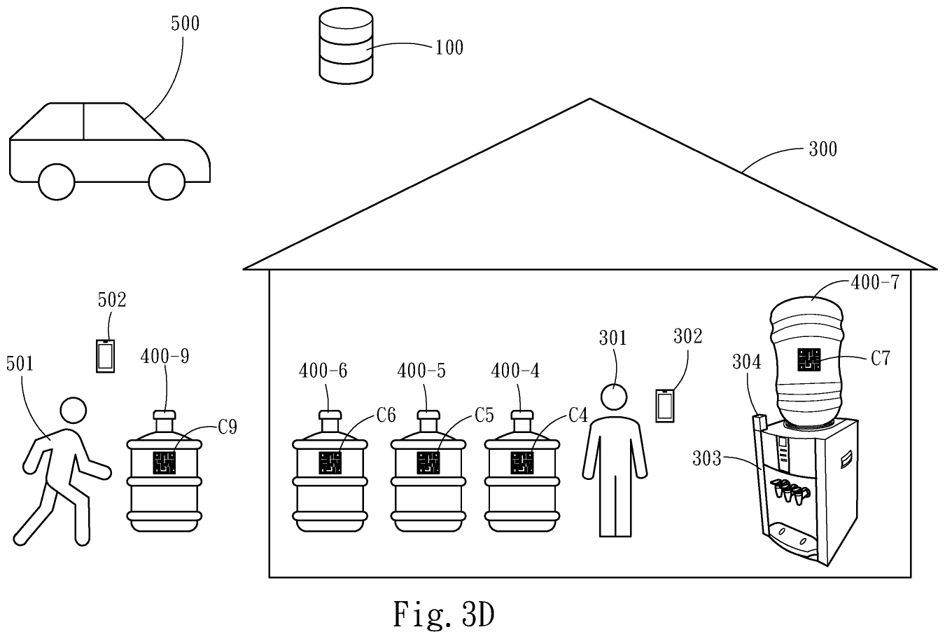

FIG. 3A through FIG. 3D illustrate an example for the smart bottled water delivery service, according to one or more embodiments. The bottled water is mounted on a water dispenser 303. The water dispenser 303 is a top loading water dispenser. In another example, the water dispenser 303 may be a water pump dispenser.

In FIG. 3A, when a customer 301 at the destination location 300 is receiving the bottled water 400-4 from the delivery driver 501, either a delivery driver device 502 or a customer device 302 may scan the machine-readable code C4 attached onto the container 401-4 of the bottled water 400-4. A result of scanning is then sent to the server 100. Then the service provider will learn about which of the bottled water is using by the customer 301 and when is the bottled water 400-4 sent to the customer 301.

FIG. 3B depicts the customer 301 orders the bottled water 400-4, 400-5, 400-6, 400-7, 400-8. Through scanning the machine-readable codes C4, C5, C6, C7, C8 by using the delivery driver device 502 or the customer device 302 when delivering, the server 100 will learn which of the bottled water are keeping by the customer 301 and how many bottled waters are currently held by the customer 301 (a first data) by obtaining the scanning result. In FIG. 3B, the first data is 5.

In an example, when the customer 301 is replacing the bottled water on the water dispenser 303, the machine-readable code on the container of the bottled water can be scanned by the customer device 302. For example, when the bottled water 400-5 replaces the bottled water 400-4 in FIG. 3B, the customer 301 uses the customer device 302 to scan the machine-readable codes C4, C5 and update the status of the bottled waters 400-4, 400-5 through the customer application. For instance, the customer 301 may set the status of the bottled waters 400-4, 400-5 as “empty” and “currently use”, respectively. Since the customer application can communicate via one or more networks with the server 100, the server 100 can obtain a total number of the bottled water used up by the customer (a second data).

Continuing with FIG. 3C, the bottled waters 400-4, 400-5, 400-6 represent the spent bottled water, the bottled water 400-7 represents the one currently using, and the bottled water 400-8 represents the full one. The total number of bottled waters currently hold by the customer 301 (the first data) is 5 and the total number of the spent bottled waters used up by the customer 301 (the second data) is 3.

Consequently, the server 100 may determine whether a difference between the total number of the bottled water currently hold by the customer and the total number of the bottled water used up by the customer is less a threshold. The threshold may be set by the customer or a default value. In an example, the threshold may be 2. If the difference is less than the threshold, the server 100 will send a replenishment message to the customer device 302 for the customer 301 to confirm whether or not to place a replenishment order. Alternatively, the customer 301 may place another order manually.

Continuing with FIG. 3D, when the delivery driver 501 delivers a new bottled water 400-9 to the customer 301, the customer 301 needs to swap the spent bottled waters 400-4, 400-5, 400-6 for the full one (e.g., the new bottled water 400-9). Either the delivery driver device 502 or the customer device 302 may scan the machine-readable code C4, C5, C6, C9 attached onto the spent container of the bottled waters 400-4, 400-5, 400-6 and the new bottled water 400-9. A scanning result is then sent to the server 100 from the delivery driver device 502 or the customer device 302. The server 100 combines the scanning result (e.g., corresponding identification number) with the customer information (e.g., name or identification number of the customer) to generate a customer-based data of the particular bottled water. Table 1 below includes some exemplary, non-limiting customer-based data.

In a further example, the server 100 collects a plurality of the customer-based data for the particular container to obtain a container-relevant data of the particular container. The container-relevant data includes a number of usages for the particular container. In an example, the container-relevant data includes a history data of the customers corresponding to the particular container and/or a number of usages for the particular container. In an example, the number of usages for the particular container is a number of refilled times or a number of orders corresponding to the particular container. Table 2 below includes some exemplary, non-limiting container-relevant data. In Table 1 and Table 2, names of the customer and the deliverer (the delivery driver) are represented by an identification number.

In a further example, the server 100 sends a notification to the customer based on a condition of the spent bottled water 400-4, 400-5, 400-6 retrieved from the customer 301 and the customer-based history of the spent bottled water 400-4, 400-5, 400-6 retrieved from the customer 301. For an instance, when the service provider found any damage or dirty on the container of the spent bottled water 400-4, 400-5, 400-6, the server 100 sends a reminder notification to the customer 301.

TABLE 1

| ID | Pervious Order | | | | Current Order | | |
|---|---|---|---|---|---|---|---|
| ID | Delivery Date | Deliverer | Customer | Retrieved Date | Delivery Date | Deliverer | Customer |
| 400-4 | Jan. 1, 2018 | 00003 | 00001 | Jan. 7, 2018 | N/A | N/A | N/A |
| 400-5 | Jan. 1, 2018 | 00003 | 00001 | Jan. 7, 2018 | N/A | N/A | N/A |
| 400-6 | Jan. 1, 2018 | 00003 | 00001 | Jan. 7, 2018 | N/A | N/A | N/A |
| 400-9 | Dec. 15, 2017 | 00007 | 00005 | Dec. 28, 2017 | Jan. 1, 2018 | 00009 | 00001 |

TABLE 2

| ID | Pervious Customers | Refilled Times | Number of Orders |
|---|---|---|---|
| 400-4 | 00002, 00003, 00001 | 3 | 3 |
| 400-5 | 00003, 00001 | 2 | 2 |
| 400-6 | 00003, 00001 | 2 | 2 |
| 400-9 | 00005 | 1 | 1 |

It provides the advantage of being able to track a history of a particular container of the bottled water. For instance, if the customer 301 in FIG. 3B ask the delivery driver 501 to leave at door and then claim that him did not receive the bottled water 400-5 (but in fact, he did receive it). In a conventional way, the service provider will accept responsibility for loss and make up for the delivery driver 501. Based on the system of the present disclosure, when the customer 301 returns the empty container of the bottled water for the full one as shown in FIG. 3D. The service provider may find whether the customer 301 received the bottled water 400-5 in earlier times by scanning the machine-readable code C5 attached onto the empty container.

Owing to the trackable and identifiable features provided by the present disclosure, the management of recycling the container of the bottled water is more efficient. In an instance, the service provider may specify a cycle life for the container. By scanning the machine-readable code when refilling, returning and/or delivering, the service provider would easily determine whether the particular container reached the predetermined cycle life and then decide to discard it. In another instance, if the container of the bottled water returned from the customer is found to be damaged or seriously worn, the service provider may notify the last customer to use it carefully or even claim compensation.

In another embodiment, the usage analysis for a particular customer is performed by obtaining and comparing a first data indicating a total number of the bottled water currently hold by the customer and a second data which is dependent on the following:
1. a total number of the bottled water used up by the customer, that is generated by scanning the machine-readable code on the empty container of the bottled water which hold by the customer.
2. a detection of a remainder amount or a consumed amount of the bottled water in use.

In an example, a sensor 304 may be incorporated to detect the remainder and/or the consumed amount of the bottled water in use. The sensor 304 may be an IR sensor that is able to measure water level. The sensor 304 may connect wirelessly to the customer device 302 through Bluetooth or Wi-Fi network, then the customer application can obtain the remainder and/or the consumed amount of the bottled water.

Consequently, the server 100 may determine whether a difference between the total number of the bottled water currently hold by the customer and the total number of the bottled water used up by the customer is less a first threshold, and also determine whether the remainder and/or the consumed amount reaches a second threshold. Both of the thresholds may be set by the customer or a default value. If the difference is less than the first threshold and the remainder and/or the consumed amount reaches the second threshold, the server 100 will send a replenishment message to the customer device for the customer to confirm whether or not to place a replenishment order.

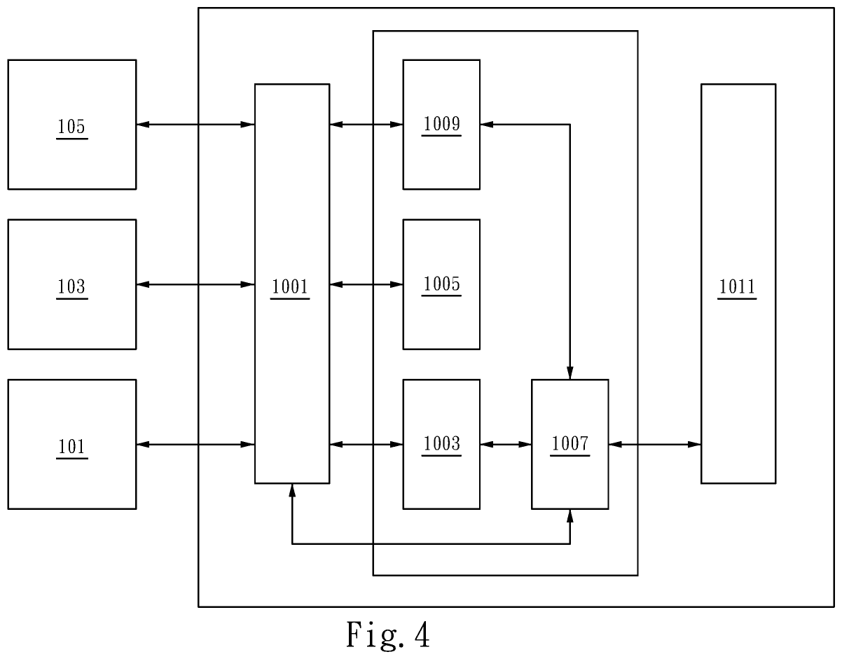

FIG. 4 is a block diagram of the system according to one or more embodiments. The system includes the server 100, a customer device 101, a lock management device 103, and a delivery driver device 105. In an example, the customer device 101 is a device operated by individuals that are requesting or ordering a smart bottled water delivery service. The lock management device 103 may be a smart locker or a combination of a locker with a smart padlock, which can connect to one or more networks as described above. The delivery driver device 105 is a device operated by individuals that can provide the smart bottled water delivery service.

The server 100 can communicate via one or more networks with the customer device 101, the lock management device 103, and the delivery driver device 105 through a device interface 1001. The device interface 1001 includes a first interface, a second interface and a third interface that each enables and manages communications between the server 100 and the devices 101, 103, 104, respectively. The server 100 further includes a customer positioning unit 1003, a delivery driver positioning unit 1005, a selector 1007, an authentication unit 1009 and a storage unit 1011.

The server 100 receives a customer data from a plurality of customer device 103 and a driver data from a plurality of delivery driver device 107 at different times depending on implementation. The customer data can provide current information about the respective devices and/or their respective users, such as identification information of users, position information of users, service preference, destination location, and/or order details. The driver data can provide current information about the respective devices and/or their respective users, such as identification information of users, position information of users, type of vehicle the delivery driver drives or the service that the delivery driver provides, the availability status (the service provider is available for service, is off-duty, or is currently servicing other customers), and/or the current state of the delivery driver.

Each of the customer positioning unit 1003 and the delivery driver positioning unit 1005 can receive the customer data and the driver data from the device interface 1001, respectively. The customer positioning unit 1003 can use a geographic data stored in the storage unit 1011 and the received customer data to determine the pool of candidate delivery drivers within a geographic region that can satisfy the criterion. In an example, the geographic region is the service region as described above.

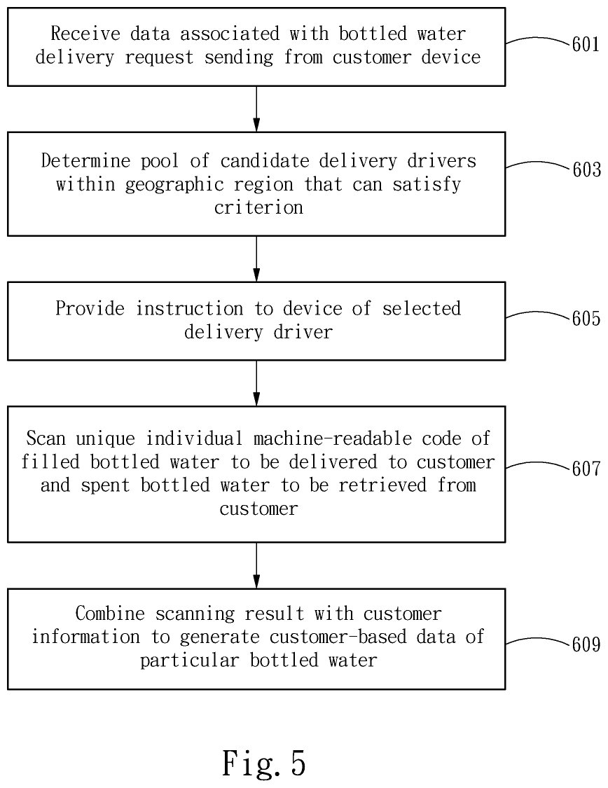

FIG. 5 depicts a flow chart of the method for a smart bottled water delivery service. The content of each step may refer to the above descriptions and figures, which is not described in detail herein.

At the beginning, the customer makes a bottled water delivery request by using a service application on his or her customer device, which is downloaded from the server 100. The request is fulfilled by the customer. Then the server 100 receives a data associated with a bottled water delivery request sending from the customer device (601).

The server 100 determines a particular delivery driver satisfies a criterion based on a plurality of parameter (603). The request is an information based on an order placed by the customer, which may include a customer information, a destination location, a quantity of bottled water, a type of water, and an expected delivery data/time. The server 100 could determine a pool of candidate delivery drivers that can satisfy a criterion based on a current location of the candidate delivery drivers, a capacity of a vehicle of the candidate delivery drivers, locations of a plurality of available collection, storing and distribution devices and the destination location. The selector 1007 of the processor 701 then pick up one of the vehicles and provide the instruction to the drive device of the selected one so as to dispatch the particular vehicle to travel to the designated collection, storing and distribution device.

The parameter may be at least one of the following: a current location of the vehicle, a capacity of the vehicle, locations of a plurality of available collection, storing and distribution devices and the destination location. In an example, the criterion is satisfied if:
1. The capacity of the vehicle of candidate delivery drivers meets the requirement of loading the amount of bottled water specified in the request; and
2. the vehicle of candidate delivery drivers with shortest distance and/or the minimal time the delivery driver has to travel and/or spend to either the available collection, storing and distribution devices or the destination location.

For example, in FIG. 1B the vehicle 500-1 will be selected if an average of a first distance from the current location of the vehicle 500-1 to the device 200-1 and a second distance from the current location of the vehicle 500-1 to the destination location 300-1 is shortest among the candidate delivery drivers; and the vehicle 500-1 is able to pick up the quantity of bottled water corresponding to the bottled water delivery request.

Then, the server 100 provides an instruction to dispatch the particular vehicle to travel to a designated collection, storing and distribution device to pick up bottled water according to the bottled water delivery request (605), as shown in FIG. 1C and FIG. 1D. In an example, the instruction may be a message or a notification sent in the delivery driver application. After receiving the instruction, the delivery driver goes to a designated collection, storing and distribution device through the use of the particular vehicle to pick up the bottled water.

Subsequently, the unique individual machine-readable code of the filled bottled water to be delivered to the customer and the spent bottled water to be retrieved from the customer are scanned to generate a scanning result (607). As shown in FIG. 3D, either the delivery driver device 502 or the customer device 302 may scan the machine-readable code C4, C5, C6, C9 attached onto the spent container of the bottled waters 400-4, 400-5, 400-6 and the new bottled water 400-9. A scanning result is then sent to the server 100 from the delivery driver device 502 or the customer device 302. The server 100 combines the scanning result (e.g., corresponding identification number) with the customer information (e.g., name of the customer) to generate a customer-based data of the particular bottled water.

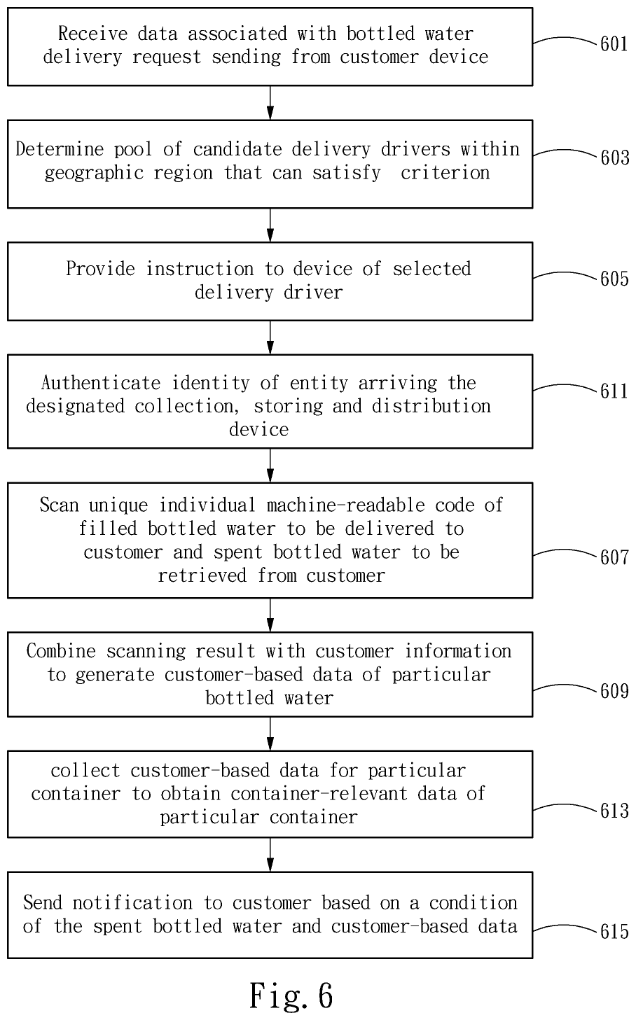

FIG. 6 depicts a flow chart of the method according to another embodiment of the present disclosure. In addition to the steps discussed above, when the delivery driver arrives the designated collection, storing and distribution device, the server 100 may further authenticate whether the delivery driver traveled to the collection, storing and distribution device is the delivery driver that received the instruction (611). In an example, as shown in FIG. 2, the authentication is a process of verifying whether the delivery driver is the one received the instruction by scanning a code (QR code or bar code) shown with the delivery driver device or using NFC. The collection, storing and distribution device or the locker may be installed with a scanner or a NFC reader to process the authentication. Once the authentication is successful, the collection, storing and distribution device will allow the delivery driver to get the bottled water. In an example, the locker will open up when the authentication is successful.

Subsequently, the delivery driver transports the bottled water to the destination location according to the instruction. In an example, when the bottled water is delivered to the designated destination location, the customer needs to swap the empty container of the bottled water for the full one (e.g., the new bottled water ordered by the customer). Either the delivery driver device or the customer device may scan the machine-readable code attached onto the empty container of the bottled water and the new bottled water. A result of scanning is then sent to the server 100 from the delivery driver device or the customer device. The server 100 retrieves a record of the result, then collects a plurality of records to obtain the container-relevant information of the bottled water, which includes a number of usages for the container and each of the customers corresponding to the container.

In a further example, the server 100 collects a plurality of the customer-based data for the particular container to obtain a container-relevant data of the particular container (611). The container-relevant data includes a number of usages for the particular container In an example, the container-relevant data includes a history data of the customers corresponding to the particular container and/or a number of usages for the particular container. In an example, the number of usages for the particular container is a number of refilled times or a number of orders corresponding to the particular container. Then, the server 100 may send a notification to the customer based on a condition of the spent bottled water 400-4, 400-5, 400-6 retrieved from the customer 301 and the customer-based history of the spent bottled water 400-4, 400-5, 400-6 retrieved from the customer 301 (615). When the service provider found any damage or dirty on the container of the spent bottled water 400-4, 400-5, 400-6, the server 100 sends a reminder notification to the customer 301.

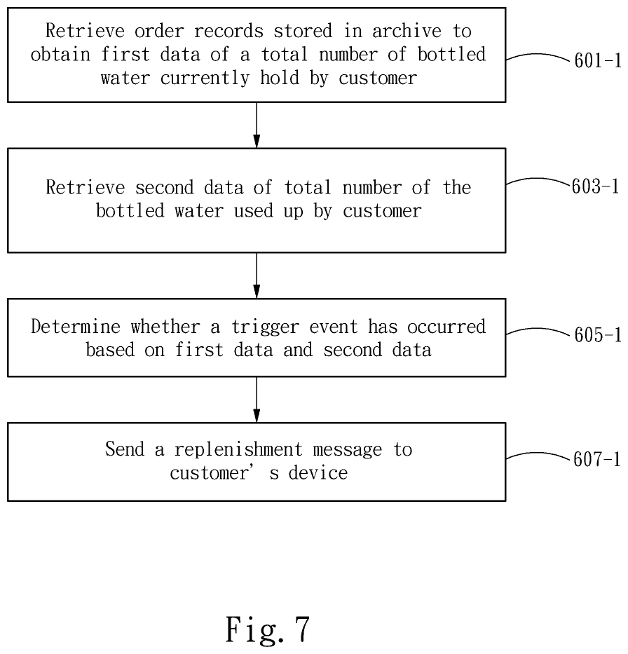

FIG. 7 depicts a flow chart of the method according to another embodiment of the present disclosure. The server 100 retrieves a plurality of order records stored in an archive to obtain a first data of a total number of bottled water currently hold by a customer (601-1) and retrieves a second data of a total number of the bottled water used up by the customer (603-1). Subsequently, the server 100 determines whether a trigger event has occurred based on the first data and the second data. In an example, the server 100 may determine whether a difference between the first data and the second data is less a threshold. The threshold may be set by the customer or a default value (605-1). In an example, the threshold may be 2. If the difference is less than the threshold, the server 100 will send a replenishment message to the customer device for the customer to confirm whether or not to place a replenishment order (607-1).

If the trigger event has occurred, the server 100 sends a replenishment message to a customer's device for the customer to confirm whether or not to place a replenishment order (605-1). When the server 100 receives a data associated with the replenishment order. The server 100 may perform the steps of 601 through 609 as described in FIG. 5 and FIG. 6.

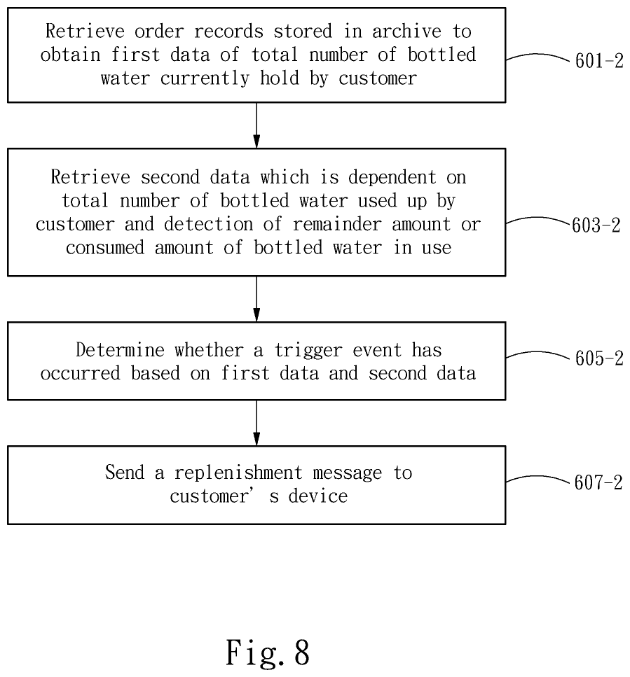

FIG. 8 depicts a flow chart of the method according to another embodiment of the present disclosure.

The server 100 retrieves a plurality of order records stored in an archive to obtain a first data of a total number of bottled water currently hold by a customer (601-2) and retrieves a second data which is dependent on the following (603-2):
1. a total number of the bottled water used up by the customer, that is generated by scanning the machine-readable code on the empty container of the bottled water which hold by the customer.
2. a detection of a remainder amount or a consumed amount of the bottled water in use.

The server 100 may determine whether a difference between the first data and the second data is less a first threshold, and also determine whether the remainder and/or the consumed amount reaches a second threshold. Both of the thresholds may be set by the customer or a default value (605-2). If the difference is less than the first threshold and the remainder and/or the consumed amount reaches the second threshold, the server 100 will send a replenishment message to the customer device for the customer to confirm whether or not to place a replenishment order (607-2). When the server 100 receives a data associated with the replenishment order. The server 100 may perform the steps of 601 through 609 as described in FIG. 5 and FIG. 6.

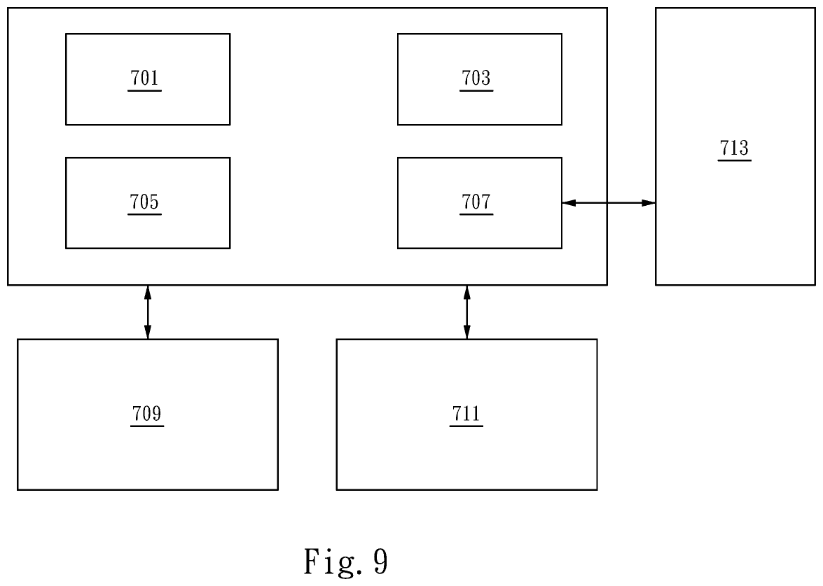

FIG. 9 illustrates a computer system upon which examples described herein may be implemented. For example, in the context of FIG. 1A through 1D and FIG. 3A through 3D, the server 100 may be implemented using a computer system 700 such as described by FIG. 9. The server 100 may also be implemented using a combination of multiple computer systems as described by FIG. 9. The server 100 includes a computer system 700. The computer system 700 includes at least one processor 701 for processing information, a main memory 703 (such as a random access memory (RAM) or other dynamic storage device, for storing information and instructions to be executed by the processor 701 or storing temporary variables or other intermediate information during execution of instructions to be executed by processor 701), a read only memory (ROM) 705 or other static storage device for storing static information and instructions for processor 701 and a communication interface 707. The server 100 further includes a display device 709 and an input device 711. In an example, the display device 709 is for displaying graphics and information to the user and the input device 711 is a keyboard, which are coupled to the computer system 700 for communicating information and command selections to the processor 701. Other non-limiting, illustrative examples of input device 711 include a mouse, a trackball, touch-sensitive screen, or cursor direction keys for communicating direction information and command selections to the processor 701 and for controlling cursor movement on the display device 709. The communication interface 707 enables the computer system 700 to communicate with one or more networks 711 (e.g., cellular network) through use of the network link.

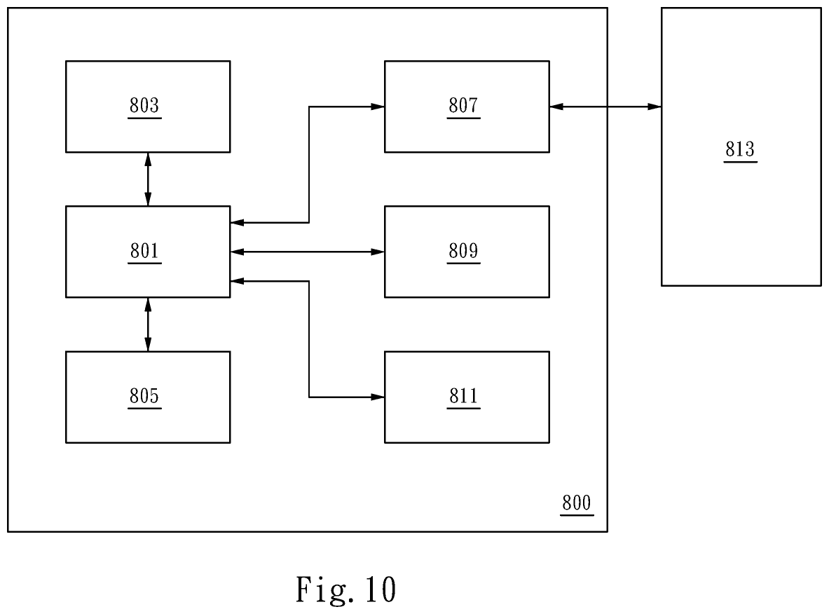

FIG. 10 illustrates a mobile computing device upon which examples described herein may be implemented. For example, the customer device and the delivery driver may be implemented using a mobile computing device 800 such as described by FIG. 10. In one example, the mobile computing device 800 may correspond to a mobile computing device, such as a cellular device that is capable of telephony, messaging, and data services. Examples of such devices include smartphones, handsets or tablet devices for cellular carriers. The mobile computing device 800 includes a processor 801, memory unit 803, a display device 805, a communication unit 807, input mechanisms 809 (e.g., an input mechanism can include or be part of the display device 805 such as a touch-sensitive display device), and one or more location detection mechanisms (e.g., GPS component) 811. The communication unit 807 enables the computing device 800 to communicate with one or more networks 813 (e.g., cellular network) through use of the network link.

What is claimed is:

1. A system for providing a smart bottled water delivery service based on usage analysis, comprising:
a plurality of bottled waters, each of the plurality of bottled waters comprising a reusable container and a unique individual machine-readable code attached onto the container, wherein the unique individual machine-readable code is pre-assigned to the container based on at least one batch information of the corresponding bottled water;
one or more processors of a network-accessible server; and
one or more memory resources storing program instructions when executed on the one or more processors, cause the system to:
retrieving a plurality of order records stored in an archive to obtain a first data of a total number of bottled water currently hold by a customer;
retrieving a second data of a total number of the bottled water used up by the customer, that is generated by scanning the machine-readable code on the spent container of the bottled water which hold by the customer;
determining whether a trigger event has occurred based on the first data and the second data;
after the trigger event has occurred, sending a replenishment message to a customer's device for the customer to confirm whether or not to place a replenishment order;
receiving data associated with the replenishment order, wherein the replenishment order indicating a customer information, a destination location, a quantity of bottled water and a type of water for the smart bottled water delivery service;
determining a pool of candidate delivery drivers that can satisfy a criterion based on a current location of the candidate delivery drivers, a capacity of a vehicle of the candidate delivery drivers, locations of a plurality of available collection, storing and distribution devices and the destination location, wherein the collection, storing and distribution devices being situated at a particular location where the candidate delivery drivers can access and exchange bottled water;
providing an instruction to a device of a selected delivery driver to dispatch the selected delivery driver with a particular vehicle to a designated collection, storing and distribution device and then a designated destination location after fetching bottled water according to the bottled water delivery request from the designated collection, storing and distribution device; and
scanning the unique individual machine-readable code of the filled bottled water to be delivered to the customer and the spent bottled water to be retrieved from the customer to generate a scanning result;
combining the scanning result with the customer information to generate a customer-based data of the particular bottled water.

2. The system of claim 1, wherein the code is a QR code.

3. The system of claim 1, wherein the trigger event occurs if a difference between the first data and the second data is less than a threshold.

4. The system of claim 1, wherein when the selected delivery driver arrived the designated collection, storing and distribution device, further cause the one or more processors to authenticate an identity of an entity arriving the designated collection, storing and distribution device is the selected delivery driver received the instruction to allow removal of the bottled water from the designated collection, storing and distribution device.

5. The system of claim 1, wherein the instructions, when executed on the one or more processors, further cause the one or more processors to:
collecting a plurality of the customer-based data for the particular container to obtain a container-relevant data of the particular container, wherein the container-relevant data includes a number of usages for the particular container.

6. The system of claim 5, wherein the container-relevant data includes a history data of the customers corresponding to the particular container.

7. The system of claim 5, wherein the container-relevant data includes a number of usages for the particular container.

8. The system of claim 7, wherein the number of usages for the particular container is a number of refilled times.

9. The system of claim 7, wherein the number of usages for the particular container is a number of orders corresponding to the particular container.

10. The system of claim 1, wherein the instructions, when executed on the one or more processors, further cause the one or more processors to:
sending a notification to the customer based on a condition of the spent bottled water retrieved from the customer and the customer-based data of the spent bottled water retrieved from the customer.

11. A system for providing a smart bottled water delivery service based on usage analysis, comprising:
a plurality of bottled waters, each of the plurality of bottled waters comprising a reusable container and a unique individual machine-readable code attached onto the container, wherein the unique individual machine-readable code is pre-assigned to the container based on at least one batch information of the corresponding bottled water;
one or more processors of a network-accessible server; and
one or more memory resources storing program instructions when executed on the one or more processors, cause the system to:
retrieving a plurality of order records stored in an archive to obtain a first data of a total number of bottled water currently hold by a customer;
retrieving a second data which is dependent on the following:
a total number of the bottled water used up by the customer, that is generated by scanning the machine-readable code on the spent container of the bottled water which hold by the customer; and
a detection of a remainder amount or a consumed amount of the bottled water in use;
determining whether a trigger event has occurred based on the first data and the second data;
after the trigger event has occurred, sending a replenishment message to a customer's device for the customer to confirm whether or not to place a replenishment order;
receiving data associated with the replenishment order, wherein the replenishment order indicating a customer information, a destination location, a quantity of bottled water and a type of water for the smart bottled water delivery service;
determining a pool of candidate delivery drivers that can satisfy a criterion based on a current location of the candidate delivery drivers, a capacity of a vehicle of the candidate delivery drivers, locations of a plurality of available collection, storing and distribution devices and the destination location, wherein the collection, storing and distribution devices being situated at a particular location where the candidate delivery drivers can access and exchange bottled water;
providing an instruction to a device of a selected delivery driver to dispatch the selected delivery driver with a particular vehicle to a designated collection, storing and distribution device and then a designated destination location after fetching bottled water according to the bottled water delivery request from the designated collection, storing and distribution device; and
scanning the unique individual machine-readable code of the filled bottled water to be delivered to the customer and the spent bottled water to be retrieved from the customer to generate a scanning result;
combining the scanning result with the customer information to generate a customer-based data of the particular bottled water.

12. The system of claim 11, wherein the code is a QR code.

13. The system of claim 11, wherein when the selected delivery driver arrived the designated collection, storing and distribution device, further cause the one or more processors to authenticate an identity of an entity arriving the designated collection, storing and distribution device is the selected delivery driver received the instruction to allow removal of the bottled water from the designated collection, storing and distribution device.

14. The system of claim 11, wherein the trigger event occurs if a difference between the total number of bottled water currently hold by the customer and the total number of the bottled water used up by the customer is less than a first threshold, and the remainder amount or the consumed amount of the bottled water in use reaches a second threshold.

15. The system of claim 11, wherein the instructions, when executed on the one or more processors, further cause the one or more processors to:
collecting a plurality of the customer-based data for the particular container to obtain a container-relevant data of the particular container, wherein the container-relevant data includes a number of usages for the particular container.

16. The system of claim 15, wherein the container-relevant data includes a history data of the customers corresponding to the particular container.

17. The system of claim 15, wherein the container-relevant data includes a number of usages for the particular container.

18. The system of claim 17, wherein the number of usages for the particular container is a number of refilled times.

19. The system of claim 17, wherein the number of usages for the particular container is a number of orders corresponding to the particular container.

20. The system of claim 11, wherein the instructions, when executed on the one or more processors, further cause the one or more processors to:
sending a notification to the customer based on a condition of the spent bottled water retrieved from the customer and the customer-based data of the spent bottled water retrieved from the customer.
